(19) United States
(12) Patent Application Publication
(10) Pub. No.: US 2024/0240801 A1
(43) Pub. Date: Jul. 18, 2024

(54) Control Units and Methods for Controlling Operation of a Heat Generation Plant of an Energy System

(71) Applicant: Siemens Aktiengesellschaft, München (DE)

(72) Inventors: Thanh Phong Huynh, Unna (DE); Sebastian Thiem, Neustadt an der Aisch (DE)

(73) Assignee: Siemens Aktiengesellschaft, München (DE)

(21) Appl. No.: 18/562,688

(22) PCT Filed: Mar. 23, 2022
(86) PCT No.: PCT/EP2022/057608

§ 371 Date: Nov. 20, 2023

(30) Foreign Application Priority Data
May 21, 2021 (EP) 21175319.9

(51) Int. Cl. F24D 19/10; G05D 23/19

(52) U.S. Cl. CPC F24D 19/1039; G05D 23/1923; F24D 2200/12

(57) ABSTRACT

Various embodiments of the teachings herein include a control unit for controlling operation of a heat generation installation of an energy system linked to a heat network. The control unit may: control an amount of thermal power in from or out to the heat network; determine an excess thermal power from the difference between a maximum power of the installation and a thermal power required for the system; operate the installation for providing the required thermal power in the time steps for which; and put out the excess thermal power generated by the heat generation installation at these points in time into the heat network.

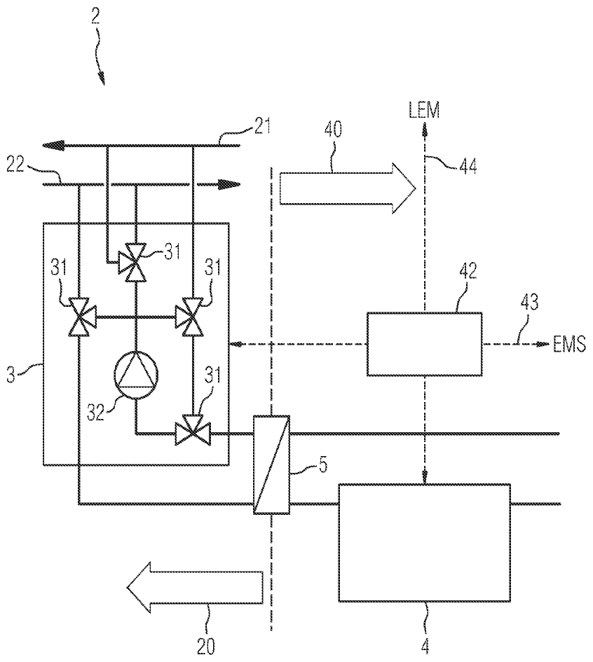

### CROSS-REFERENCE TO RELATED APPLICATIONS

This application is a U.S. National Stage Application of International Application No. PCT/EP2022/057608 filed Mar. 23, 2022, which designates the United States of America, and claims priority to EP Application No. 21175319.9 filed May 21, 2021, the contents of which are hereby incorporated by reference in their entirety.

### TECHNICAL FIELD

The present disclosure relates to energy systems. Various embodiments of the teachings herein include control units and/or methods for controlling operation of a heat generation plant.

### BACKGROUND

Energy systems, for example a town/city, an industrial area or a building, are characterized by decentralized generation of electrical and thermal energy. Furthermore, energy systems can exchange electrical and/or thermal energy with supply networks that are external to the energy systems, for example electricity grids or heat networks.

Energy systems for providing heat, for example for covering an internal heat demand of the energy systems, typically have one or more heat generation installations. The latter can draw electrical and/or thermal energy via the respective supply networks and thereby provide the required heat or thermal power for the energy system.

Furthermore, energy systems can be integrated into a local energy market. In this case, the allocation of energies is effected by way of the aforementioned local energy market, which brings together and coordinates purchase offers and sales offers of the various forms of energy, in particular electrical energy and thermal energy. From a technical standpoint, the local energy market is realized by a control platform that controls the energy exchanges between the energy systems. Such a control platform (energy market, energy market platform, trading platform) is known for example from the document EP 3518369 A1.

When integrating heat generation installations into such a local energy market, there is the problem that the heat generation installations are operated independently of their capacity utilization. Just the maximum capacity utilization of the respective heat generation installation must not be exceeded. However, the coefficient of performance of typical heat generation installations depends on their capacity utilization. In particular, in the case of heat pumps a high capacity utilization should be sought in order to convert electrical energy into thermal energy or heat as efficiently as possible. At the same time, however, further secondary technical requirements, such as the least possible carbon dioxide emissions during operation, for example, should be taken into consideration. As a result, it can nevertheless be disadvantageous to operate every installation of the energy system with the highest possible capacity utilization.

### SUMMARY

The present disclosure provides teachings for improving the efficiency of the heat generation by means of a heat generation installation of an energy system, in particular in regard to carbon dioxide emissions of the energy system. For example, some embodiments of the present disclosure include a control unit (42) for controlling operation of a heat generation installation (4) of an energy system, in particular of a building, the energy system being linked to a heat network (2), and feeding-in and/or outputting of a thermal power into the heat network (2) being controllable by means of the control unit (42), a weighting g_{e,t} being associated with the feeding-in, a weighting g_{d,t} being associated with the outputting, and a weighting g_{i,t} being associated with heat generation by the heat generation installation (4), characterized in that the control unit (42) is designed: to determine an excess thermal power P_{excess,t}^{th} from the difference between a maximum thermal power P_{max,t}^{th} of the heat generation installation (4) and a thermal power P_{demand,t}^{th} required for the energy system; to operate the heat generation installation (4) for providing the required thermal power P_{demand,t}^{th} in the time steps for which P_{demand,t}^{th}·g_{d}≥P_{max,t}^{th}·gᵢ−P_{excess,t}^{th}·gₑ; and to output the excess thermal power P_{excess,t}^{th} generated by the heat generation installation (4) at these points in time into the heat network (2).

In some embodiments, each of the weightings g_{d}, gᵢ and gₑ is a pollutant variable or an environment variable.

In some embodiments, each of the weightings g_{d}, gᵢ and gₑ is a specific carbon dioxide emission.

In some embodiments, the heat generation installation (4) is designed as a heat pump having a coefficient of performance COPₜ, the control unit (42) being designed to determine the maximum thermal power from a maximum electrical power of the heat pump by means of P_{max,t}^{th}=COPₜ·P_{max,t}^{el}.

In some embodiments, the control unit (42) is designed to receive at least one measured value of an external temperature Tₜ from a measuring unit of the energy system, and to determine therefrom the coefficient of performance COPₜ=COPₜ(Tₜ) as a function of the external temperature Tₜ.

In some embodiments, the control unit (42) is designed to control the feeding-in into the heat network (2) in such a way that the excess thermal power P_{excess,t}^{th} is fed into a feed of the heat network (2).

In some embodiments, the control unit (42) is designed to control the feeding-in into the heat network (2) in such a way that the excess thermal power P_{excess,t}^{th} is fed into a return of the heat network (2).

In some embodiments, the control unit (42) is designed to control the feeding-in into the heat network (2) in such a way that the temperature of the return and/or the feed of the heat network (2) is increased by the feeding-in of the excess thermal power P_{excess,t}^{th}.

In some embodiments, the control unit (42) is designed to control the feeding-in and/or outputting from the feed and/or return of the heat network (2) by way of switching of valves (31).

In some embodiments, there is a communication module that enables data exchange with a central control device (44) with respect to a plurality of energy systems, the central control device (44) controlling energy exchanges between the energy systems, and the communication module being designed to receive the weightings g_{d}, gᵢ and gₑ from the central control device (44).

As another example, some embodiments include a method for controlling operation of a heat generation installation (4) of an energy system, in particular of a building, the energy system being linked to a heat network (2), and feeding-in and/or outputting of a thermal power into the heat network (2) being controllable by means of a control unit (42), a weighting g_{e,t} being associated with the feeding-in, a weighting g_{d,t} being associated with the outputting, and a weighting g_{i,t} being associated with heat generation by the heat generation installation (4), characterized in that: an excess thermal power P_{excess,t}^{th} is determined from the difference between a maximum thermal power P_{max,t}^{th} of the heat generation installation (4) and a thermal power P_{demand,t}^{th} required for the energy system; the heat generation installation (4) is operated for providing the required thermal power P_{demand,t}^{th} in the time steps for which P_{demand,t}^{th}·g_{d}≥P_{max,t}^{th}·gᵢ−P_{excess,t}^{th}·gₑ; and the excess thermal power P_{excess,t}^{th} generated by the heat generation installation (4) at these points in time is output into the heat network (2).

In some embodiments, the feeding-in into the heat network (2) is effected according to a first feed-in mode, in which case the excess thermal power P_{excess,t}^{th} generated by the heat generation installation (4) is transferred to a return of the heat network (2) and the return, the temperature of which has been increased as a result, is fed to a feed of the heat network (2).

In some embodiments, the feeding-in into the heat network (2) is effected according to a second feed-in mode, in which case the excess thermal power P_{excess,t}^{th} generated by the heat generation installation (4) is transferred to a return of the heat network (2) and the return, the temperature of which has been increased as a result, is fed back into the return of the heat network (2).

In some embodiments, the feeding-in into the heat network (2) is effected according to a third feed-in mode, in which case the excess thermal power P_{excess,t}^{th} generated by the heat generation installation (4) is transferred to a feed of the heat network (2) and the feed, the temperature of which has been increased as a result, is fed back into the feed of the heat network (2).

In some embodiments, the weightings g_{d}, gᵢ and gₑ are provided by a central control device (44) with respect to a plurality of energy systems.

### BRIEF DESCRIPTION OF THE DRAWINGS

Further advantages, features and details of the teachings herein are apparent from the exemplary embodiments described below and with reference to the drawing.

In this case, the single FIGURE schematically shows an overall system comprising an example control unit incorporating teachings of the present disclosure.

Identical, equivalent or functionally identical elements may be provided with the same reference signs in the FIGURE.

### DETAILED DESCRIPTION

Various embodiments of the teachings herein include control units for controlling operation of a heat generation installation of an energy system, in particular of a building, the energy system being linked to a heat network, and feeding-in and/or outputting of a thermal power into the heat network being controllable by means of the control unit, a weighting g_{e,t} being associated with the feeding-in, a weighting g_{d,t} being associated with the outputting, and a weighting g_{i,t} being associated with heat generation by the heat generation installation. The control unit is designed:
to determine an excess thermal power P_{excess,t}^{th} from the difference between a maximum thermal power P_{max,t}^{th} of the heat generation installation and a thermal power P_{demand,t}^{th} required for the energy system;
to operate the heat generation installation for providing the required thermal power P_{demand,t}^{th} in the time steps for which P_{excess,t}^{th}·g_{d}≥P_{max,t}^{th}·gᵢ−P_{excess,t}^{th}·gₑ; and
to output the excess thermal power P_{excess,t}^{th} generated by the heat generation installation at these points in time into the heat network.

The relative terms internal and external should be understood hereinafter in relation to the energy system. In other words, the terms internal or external and the terms internal in the energy system or external to the energy system are equivalent. In the present case, thermal power and quantity of heat are regarded as equivalent since a thermal power that is constant or varies within a time range is always associated with an associated quantity of heat within this time range.

Fundamentally time-dependent variables are denoted by an index t in the present case. A point in time can denote a time range in the discrete case. By way of example, a time range of 15 minutes is assigned an index t and thus a point in time within the meaning of the present disclosure.

Furthermore, in the present case, a point in time or time range is referred to as efficient if the inequality P_{demand,t}^{th}·g_{d}≥P_{max,t}^{th}·gᵢ−P_{excess,t}^{th}·gₑ is satisfied for it. The succession of a plurality of points in time can denote a new continuous time range that is likewise efficient within the meaning of the present disclosure.

From a structural viewpoint, the IPCC Fifth Assessment Report in particular defines an energy system as: “All components related to the generation, conversion, delivery and use of energy” (see Annex I, page 1261). In the context of this disclosure, an energy system is in particular a town/city, part of a town/city, a district, a residential area, a campus, a building, a residential building, an office building, an industrial area, and industrial installation and/or any other constructional structure that is delimitable in relation to energy conversion, energy delivery and/or energy use.

The energy system can comprise one or more of the following components as energy installations: electricity generators, cogeneration plants, in particular combined heat and power plants, gas boilers, diesel generators, heat pumps, compression refrigeration machines, absorption refrigeration machines, pumps, district heating networks, energy transfer lines, wind farms or wind turbines, photovoltaic installations, biomass installations, biogas installations, waste incineration plants, industrial installations, conventional power plants and/or the like.

The energy system is linked to an electrical supply network (electricity grid) and thermal supply network (heat network). The outputting and/or feeding-in of heat from the energy system into the heat network and/or from the heat network into the energy system are/is controllable by means of the control units described herein. In other words, the control unit according to the invention is designed to control the heat exchange between the energy system and the heat network, in particular between the energy system and the heat network and also between the energy system and the electricity grid.

In some embodiments, the heat network comprises a district heating network and/or community heating network.

Furthermore, at least part of the heat fed in is generated by the heat generation installation. In particular, the heat generation installation converts electrical energy into heat. In other words, the heat generation installation generates heat that can be provided internally and/or externally. For this purpose, the heat generation installation can take up heat having a specific temperature level from the heat network, the ground and/or the ambient air in order to provide heat having a higher temperature level by expending electrical energy, for example from the electricity grid. The heat provided by the heat generation installation can in principle be used internally and/or be fed back into the heat network, that is to say used externally. The control unit according to the invention is thus designed to control the internal and/or external provision of the heat by the heat generation installation and/or the internal and/or external use thereof (feeding-in into the heat network).

A weighting g_{e,t} is associated with the feeding-in into the heat network, a weighting g_{d,t} is associated with the outputting from the heat network, and a weighting g_{i,t} is associated with heat generation by the heat generation installation. In other words, the feeding-in, the outputting and the internal heat generation are respectively assigned a weighting. In this case, the weightings describe secondary characteristic variables associated with the feeding-in, outputting and heat generation, for example specific carbon dioxide emissions.

The control unit can store the weightings, for example in the form of data storage. In some embodiments, the weightings can be provided for the control unit by a further unit of the energy system. Furthermore, external provision is provided. The weightings have any desired positive values.

In order to explain the weightings and the technical meaning thereof, hereinafter they are embodied typically and by way of example, in particular in a nonlimiting manner, as specific carbon dioxide emissions. In a time range, the weightings thus have the unit kg (CO₂) per kW or, if they reference a quantity of energy/quantity of heat, the unit kg (CO₂) per kWh. In other words, the feeding-in, the outputting and the internal heat generation by the heat generation installation are associated with a specific carbon dioxide emission.

In practice, the required thermal power (internal heat demand) can be covered by the heat generation installation and/or by outputting from the heat network. If it is possible for the required thermal power to be fully covered by the heat generation installation, then the heat generation installation can generate further heat up to its capacity utilization, that is to say can provide the excess thermal power. The excess thermal power is fed into the heat network.

For example with regard to the carbon dioxide emissions of the energy system, it may be advantageous to operate the heat generation installation with full capacity utilization and feeding-in of the excess thermal power if the inequality P_{demand,t}^{th}·g_{d}≥P_{max,t}^{th}·gᵢ−P_{excess,t}^{th}·gₑ is satisfied. In other words, it is advantageous to operate the heat generation installation at points in time or in time ranges that are efficient within the meaning of the present disclosure. For this purpose, for each point in time or time range denoted by t, the control unit checks whether the condition P_{demand,t}^{th}·g_{d}≥P_{max,t}^{th}·gᵢ−P_{excess,t}^{th}·gₑ is satisfied. If this condition is satisfied, a control signal is determined by the control unit to the heat generation installation, such that the latter commences the heat generation under full load.

If the weightings are carbon dioxide emissions, then the left term P_{demand,t}^{th}·g_{d} corresponds to the carbon dioxide emissions associated with the required thermal power being completely drawn via the external heat network. The right term of the required inequality corresponds to the carbon dioxide emissions associated with internal coverage (heat generation by the heat generation installation) of the required thermal power and with feeding-in of the excess thermal power into the heat network. Since these symbolically flow away from the energy system, the term for the feeding-in has a negative sign. From a technical standpoint, in the case of carbon dioxide emissions, the required inequality or condition thus ensures that the internal heat generation for covering the required thermal power takes place if the carbon dioxide balance for the energy system—assuming that the heat generation installation is operated with full load (full capacity utilization)—is better, that is to say lower, than if the required thermal power is covered by external drawing from the heat network.

In other words, the heat generation installation is operated for covering the internal heat load in the time steps for which P_{demand,t}^{th}·g_{d}≥P_{max,t}^{th}·gᵢ−P_{excess,t}^{th}·gₑ. In the time steps for which P_{demand,t}^{th}·g_{d}<P_{max,t}^{th}·gᵢ−P_{excess,t}^{th}·gₑ, by contrast, the required thermal power is taken from the external heat network. The heat pump is therefore not operated in these time steps.

In other words, the control unit is designed to control the heat generation installation in accordance with a first and a second operating mode. The first operating mode is denoted by P_{demand,t}^{th}·g_{d}≥P_{max,t}^{th}·gᵢ−P_{excess,t}^{th}·gₑ. In this case, heat is generated by the heat generation installation with full capacity utilization and the excess heat is fed into the heat network. The second operating mode is denoted by P_{demand,t}^{th}·g_{d}<P_{max,t}^{th}·gᵢ−P_{excess,t}^{th}·gₑ. In this case, the required heat is drawn via the heat network, that is to say is output from the heat network or taken from the heat network. The first operating mode is therefore a generation mode and the second operating mode is a drawing mode of the heat generation installation. The control unit is designed to define the respective operating mode or to switch between the generation mode and the drawing mode.

By virtue of the two operating modes provided, the heat generation installation can be operated with full capacity utilization and thus as energetically efficiently as possible, and at the same time a characteristic variable of the energy system that is associated with the weighting, for example the carbon dioxide emissions of the energy system, can be minimized as much as possible. The weightings can likewise be pollutant variables, for example nitrogen oxide emissions or further greenhouse gases, or can denote availability of renewable energies that are associated with feeding-in, outputting and/or generation of heat. Furthermore, a remuneration, for example a carbon dioxide price, could also be used as a respective weighting in principle.

In the case of carbon dioxide emissions, this has the effect that the CO₂ footprint of the energy system in regard to its heat generation is improved and in addition the heat generation installation is operated energetically more efficiently. In the case of the availability of renewable energies, by means of the control unit according to the invention, the energy system can react in an improved way to fluctuations of the renewably generated energies and the stated fluctuations and can thus symbolically follow the renewable generation.

In other words, without losses regarding internal (heat) convenience, the heat generation installation can be operated with the highest possible efficiency and moreover the highest possible capacity utilization of the heat pump can be achieved.

The methods incorporating teachings of the present disclosure for controlling operation of a heat generation installation of an energy system, in particular of a building, the energy system being linked to a heat network, and feeding-in and/or outputting of a thermal power into the heat network being controllable by means of a control unit, a weighting g_{e,t} being associated with the feeding-in, a weighting g_{d,t} being associated with the outputting, and a weighting g_{i,t} being associated with heat generation by the heat generation installation, are characterized in that:
an excess thermal power P_{excess,t}^{th} is determined from the difference between a maximum thermal power P_{max,t}^{th} of the heat generation installation and a thermal power P_{demand,t}^{th} required for the energy system;
the heat generation installation is operated for providing the required thermal power P_{demand,t}^{th} in the time steps for which P_{demand,t}^{th}·g_{d}≥P_{max,t}^{th}·gᵢ−P_{excess,t}^{th}·gₑ; and
the excess thermal power P_{excess,t}^{th} generated by the heat generation installation (4) at these points in time is output into the heat network.

The advantages and embodiments of the methods incorporating teachings of the present disclosure are similar and equivalent to those of the control units.

In some embodiments, each of the weightings g_{d}, gᵢ and gₑ is a pollutant variable or an environment variable, in particular a greenhouse variable. As a result, it is possible to improve the energy efficiency by way of the full capacity utilization of the heat generation installation and also the efficiency of the energy system regarding the respective pollutant variable, for example nitrogen oxides, or the efficiency of the energy system regarding the respective environment variable, for example greenhouse gas, for the coverage of the internal heat demand. The energy system thus becomes synergistically more efficient regarding the generation of heat and regarding the reduction of pollutant variables and/or environment variables. Mixed weightings can be provided, for example in the form of a product of the individual weightings. Furthermore, the weightings are typically specific, that is to say related to a thermal power (mass per power) or quantity of heat (mass per energy). The weightings thus denote the specific emission (in mass) of the respective pollutant variable, environment variable and/or greenhouse gas.

In some embodiments, each of the weightings g_{d}, gᵢ and gₑ is a specific carbon dioxide emission. In other words, respective specific carbon dioxide emissions are used for the weightings. As a result, the energy system advantageously becomes more efficient regarding the heat generation—on account of possible full-load operation—and regarding its carbon dioxide emissions.

In some embodiments, the heat generation installation is designed as a heat pump having a coefficient of performance COPₜ, the control unit being designed to determine the maximum thermal power from a maximum electrical power of the heat pump by means of P_{max,t}^{th}=COPₜ·P_{max,t}^{el}. In other words, the maximum thermal power of the heat pump is determined by means of its maximum electrical power which said heat pump takes up from the electricity grid for the purpose of generating or providing the heat or thermal power. At the points in time at which operation is more efficient, that is to say P_{demand,t}^{th}·g_{d}≥P_{max,t}^{th}·gᵢ−P_{excess,t}^{th}·gₑ, the heat pump is thus operated substantially with full capacity utilization, that is to say that said heat pump takes up its maximum electrical power. As a result, the heat pump provides substantially its maximum thermal power, this being operated at the aforementioned points in time or in the aforementioned time ranges that are efficient within the meaning of the present invention, for the coverage of the required thermal power (internal heat demand), and the excess thermal power is fed into the heat network. The power of the heat pump can preferably be controllable by the control unit.

In some embodiments, the control unit is designed to receive at least one measured value of an external temperature Tₜ from a measuring unit of the energy system, and to determine therefrom the coefficient of performance COPₜ=COPₜ(Tₜ) as a function of the external temperature Tₜ. The temperature-dependent efficiency of the heat pump or the provision of heat by the heat pump is taken into account as a result. That is the case since the temperature-dependent coefficient of performance influences the inequality for determining the efficient times. In other words, the efficient times at which the heat demand of the energy system is at least partly covered internally by the heat pump are ascertained by way of the inequality or condition P_{demand,t}^{th}·g_{d}≥COPₜ(Tₜ)·P_{max,t}^{el}·gᵢ−P_{excess,t}^{th}·gₑ. In other words, for each point in time or time range denoted by t, the condition P_{demand,t}^{th}·g_{d}≥COPₜ(Tₜ)·P_{max,t}^{el}·gᵢ−P_{excess,t}^{th}·gₑ is checked by the control unit. If this condition is satisfied, a control signal is communicated by the control unit to the heat pump, such that the latter is operated under full load. The efficiency of the provision of heat is improved further by virtue of the temperature-dependent coefficient of performance of the heat pump being taken into account in the condition.

In some embodiments, the control unit is designed to control the feeding-in into the heat network in such a way that the excess thermal power P_{excess,t}^{th} is fed into a feed of the heat network. In other words, the excess thermal power may be fed to the feed. In this case, the feeding-in can be effected by means of a heat exchanger to which is fed the feed or a return of the heat network for taking up the excess heat. The feed or return, having then been increased in respect of its temperature at the heat exchanger, is then fed to the feed. In other words, the feed or return of the heat network is led into the feed via the heat exchanger. As a result, overall the excess heat/thermal power is fed to the feed of the heat network. In this case, the heat generation installation is thermally coupled to the heat exchanger.

In some embodiments, the control unit is designed to control the feeding-in into the heat network in such a way that the excess thermal power P_{excess,t}^{th} is fed into a return of the heat network. In other words, the excess thermal power may be fed to the return. In this case, the feeding-in can be effected by means of a heat exchanger to which is fed the return of the heat network for taking up the excess heat. The return, having then been increased in respect of its temperature at the heat exchanger, is fed again to the return of the heat network. In other words, the return of the heat network is led back into the return via the heat exchanger. As a result, overall the excess heat/thermal power is fed to the return of the heat network. In this case, the heat generation installation is thermally coupled to the heat exchanger.

In some embodiments, the control unit is designed to control the feeding-in into the heat network in such a way that the temperature of the return and/or the feed of the heat network is increased by the feeding-in of the excess thermal power P_{excess,t}^{th}. In other words, the feed and/or the return of the heat network can be fed to the heat exchanger and thus increased in respect of its temperature by way of taking up the excess thermal power. Afterward, the feed, the temperature of which has been increased, is fed again to the feed. If the temperature of the return is increased at the heat exchanger or by way of the excess thermal power taken up, then said return can preferably be fed to the feed or to the return of the heat network. Three different preferred feed-in modes are formed as a result, namely return/heat uptake/feed (first feed-in mode), return/heat uptake/return (second feed-in mode) and feed/heat uptake/feed (third feed-in mode).

In other words, the feeding-in into the heat network may be effected according to the first feed-in mode, in which case the excess thermal power P_{excess,t}^{th} generated by the heat generation installation is transferred to the return of the heat network and the return, the temperature of which has been increased as a result, is fed to the feed of the heat network, or according to the second feed-in mode, in which case the excess thermal power P_{excess,t}^{th} generated by the heat generation installation is transferred to the return of the heat network and the return, the temperature of which has been increased as a result, is fed back into the return of the heat network, or according to the third feed-in mode, in which case the excess thermal power P_{excess,t}^{th} generated by the heat generation installation is transferred to the feed of the heat network and the feed, the temperature of which has been increased as a result, is fed back into the feed of the heat network.

In some embodiments, the control unit is designed to control the feeding-in and/or outputting from the feed and/or return of the heat network by way of switching of valves. In other words, the control unit is designed to switch between the three feed-in modes mentioned or to adjust the feed-in mode by way of adjusting the valves. In accordance with the first feed-in mode, the temperature of the return or of the return water is increased by the excess thermal power and fed into the feed. In accordance with the second feed-in mode, the temperature of the return or of the return water is increased by the excess thermal power and fed back into the return. In accordance with the third feed-in mode, the temperature of the feed or of the feed water is increased by the excess thermal power and fed back into the feed.

Furthermore, the control unit can be designed to control the respective mass flow of the heat transfer medium of the heat network. The heat transfer medium is water, for example.

In some embodiments, the control unit has a communication module that enables data exchange with a central control device with respect to a plurality of energy systems, the central control device controlling energy exchanges between the energy systems, and the communication module being designed to receive the weightings g_{d}, gᵢ and gₑ from the central control device. That is, the weightings g_{d}, gᵢ and gₑ are provided by a central control device with respect to a plurality of energy systems. As a result, the energy systems are coordinated by the central control device with regard to their efficiency.

This may improve the efficiency of the provision of heat, in particular in regard to the overall carbon dioxide emissions. In this case, the central control device symbolically predefines the weightings and communicates them to the energy systems or the respective control units, such that each of the energy systems can operate its heat generation installation or heat generation installations at/in the respective efficient points in time/time ranges. The central control device with respect to the energy systems calculates or determines the weightings from data/information communicated to it beforehand by the energy systems. The calculation can be effected by means of an optimization method, wherein for example the total carbon dioxide emission of all the participating energy systems is minimized. As a result, the CO₂ footprint of the energy systems can be further reduced or improved.

Furthermore, an energy management system of the energy system can comprise the control unit and thus the communication module. Since the central control device predefines the weightings and thus substantially defines when the respective heat generation installations are operated, the central control device (via the control unit) controls the heat generation and heat feeding-in. The central energy market platform thus controls, at least indirectly, the valves and/or mass flows regarding the heat transfer of the excess thermal power to the heat network. Furthermore, the central control device can control the consumption and/or the generation of electrical energy of the respective energy system. The central control device is thus designed as a local energy market platform with regard to heat and, in one advantageous embodiment, as a local energy market platform for heat and electricity. In other words, from a technical standpoint, the central control device forms a local energy market for heat and/or electricity. By means of the communication module, furthermore, offers regarding the heat outputting and/or heat feeding-in could be communicated to the central control device.

The FIGURE schematically shows a primary side 20 and a secondary side 40 with respect to a heat network 2. In this case, the primary side 20 comprises a heat network 2 and also a coupling unit 3. The coupling unit 3 couples the heat network 2 to the secondary side 40 in regard to a heat exchange. The secondary side 40 comprises or denotes the side of the energy system(s). In this case, the energy system comprises an example control unit 42 incorporating teachings of the present disclosure and also a heat pump 4.

For the purpose of coupling the heat network 2 to the heat engineering installations of the secondary side 40, in particular to the heat pump 4, provision is made of a heat exchanger 5. What is crucial for the thermal power being transferred is the temperature difference between heat source and heat sink within the heat exchanger 5 and also the mass flow of the transfer medium. The transfer medium is typically water. The temperature of the heat source, in the present case the heat pump 4 on the secondary side 40, is controllable or adjustable by the control unit 42. The mass flow can be regulated in principle by means of valves controlled by the control unit 42. In this case, depending on operating modes, the temperature of the heat source constitutes the feed temperature of the heat network 2 or the temperature following a secondary network of the energy system following an intrinsic consumption by the energy system.

The heat network 2 has a feed 20 and also a return 22. Via the coupling device 3 in conjunction with the heat exchanger 5, the feed 21 and/or return 22 of the heat network 2 are/is thermally coupled to the heat pump 4, that is to say to the heat generation installation of the energy system. For this purpose, the coupling device 3 comprises a plurality of valves 31 and also a pump 32. The hydraulic interconnection of the valves is illustrated as the inner workings of the coupling device 3 in the FIGURE. The present interconnection of the valves enables three feed-in modes of the heat generated by the heat pump 4 into the heat network 2.

In accordance with a first feed-in mode, the valves 31 are controlled by the control unit 42 in such a way that the return 22 of the heat network 2 is led via the heat exchanger 5 and back into the feed 21 of the heat network 2. In a second feed-in mode, the valves 31 are controlled by the control unit 42 in such a way that the return 22 of the heat network 2 is led via the heat exchanger 5 and back into the return 22. In other words, the circuit of the valves 31 forms a bypass for the return 22 which passes via the heat exchanger 5. In a third feed-in mode, the valves 31 are controlled by the control unit 42 in such a way that the feed 21 of the heat network 2 is led via the heat exchanger 5 and back into the feed 21. In other words, the circuit of the valves 31 forms a bypass for the feed 21 which passes via the heat exchanger 5. The control unit 42 can switch between the feed-in modes or adjust the respective feed-in mode by way of the control of the valves 31.

Furthermore, the coupling device 3 can comprise the heat exchanger 5.

The secondary side 40 or the energy system comprises the secondary heat network already mentioned above. The secondary heat network, which is merely indicated in the FIGURE, furthermore serves for distributing the heat within the energy system.

The control unit 42 is likewise arranged on the secondary side 40. In the present case, the energy system comprises the control unit 42. The control unit 42 is designed to exchange data/information, in particular control signals, regulation values and/or the like, with the coupling device 3, with the heat pump 4, with an energy management system 43 of the energy system, and also with a central control device 44 with respect to a plurality of energy systems. In the present case, the central control device 44 forms a local energy market. In other words, the control unit 42 enables communication with the coupling device 3, with the heat pump 4, with the energy management system 43 and also with the local energy market 44. These communication possibilities are elucidated in the FIGURE by the dashed arrows proceeding from the control unit 42.

The control unit 42 is thus designed to control the valves 31 and or pumps 32 of the coupling device 3 and also the heat pump 4 with regard to their operation. This control can be effected by means of control signals which the control unit generates on the basis of data received from the local energy market 44 and/or from the energy management system 43 of the energy system and transmits to the heat pump 4.

In accordance with a first step of an example method incorporating teachings of the present disclosure, an excess thermal power P_{excess,t}^{th} is determined by the control unit 42 from the difference between a maximum thermal power P_{max,t}^{th} of the heat pump 4 and a thermal power P_{demand,t}^{th} required for the energy system. For this purpose, the required thermal power is provided for the control unit 42 by the energy management system 43, for example. From the difference between the maximum possible thermal power and the thermal power required within the energy system, the control unit 42 can calculate the excess thermal power.

In a second step, the heat pump is operated for providing the required thermal power P_{demand,t}^{th} in the time steps for which P_{demand,t}^{th}·g_{d}≥P_{max,t}^{th}·gᵢ−P_{excess,t}^{th}·gₑ. In other words, the control unit checks whether the condition P_{demand,t}^{th}·g_{d}≥P_{max,t}^{th}·gᵢ−P_{excess,t}^{th}·gₑ is satisfied, the heat pump 4 being operated when said condition is satisfied. Otherwise, the required thermal power is drawn or taken from the heat network 2. For this purpose, the control unit 42 controls the heat pump 4 or the coupling device 3, in particular the valves 31 and/or 32, accordingly.

Furthermore, in a third step, the excess thermal power P_{excess,t}^{th} generated by the heat pump 4 at these points in time is output into the heat network, that is to say transferred to the heat network 2. In other words, at the points in time which satisfy the condition mentioned above, the capacity of the heat pump 4 can be fully utilized, in which case the excess thermal power that is not required internally in the energy system is delivered to the heat network 2 for further use, for example by further energy systems. As a result, the heat pump 4 is operated with full capacity utilization for a longer period, and so it has a higher coefficient of performance and thus a higher efficiency—at least in the efficient time ranges mentioned.

The efficient points in time or time ranges are defined by the condition P_{demand,t}^{th}·g_{d}≥P_{max,t}^{th}·gᵢ−P_{excess,t}^{th}·gₑ, comprising a plurality of weightings or weighting factors g_{d}, gᵢ and gₑ. From a technical standpoint, the weighting factors ensure that not just the energy efficiency of the heat pump 4, that is to say the efficiency of the generation of heat from electricity, is crucial, rather likewise further important technical characteristic variables, such as carbon dioxide emissions, for example, can be taken into account. The heat pump 4 is thus operated with full load by the control unit 4 (energy efficiency) if a lower carbon dioxide emission for the energy system can be achieved at the same time.

In other words, symbolically at or in the aforementioned efficient points in time or time ranges for the energy system it is more expedient to generate the heat itself by way of the heat pump 4 and to feed in the excess than to draw the heat from the heat network 2. At the points in time or in the time ranges at or in which the condition is not satisfied, it is symbolically more expedient for the energy system to take the heat for covering the internal heat demand from the heat network 2. The source of heat for the heat demand—heat network 2 or heat pump 4—is thus controlled dynamically by the control unit 42 as a function of the weightings. The weightings thus ensure that the technical aims of the least possible carbon dioxide emission and the highest possible energy efficiency of the heat coverage are achieved synergistically at the same time.

The weightings g_{d}, gᵢ and gₑ can be provided by the central control device 44 and or to the energy management system 43 and/or can be communicated to the control unit 42. As a result, a dynamic adaptation is possible for example with regard to the carbon dioxide emissions, since for example the carbon dioxide emissions associated with the drawing (outputting) from the heat network 2 can change over time. Furthermore, the carbon dioxide emissions associated with the heat generation can change over time. In other words, the weightings g_{d}, gᵢ and gₑ can be time-dependent, such that they are communicated to the control unit 42 at regular time intervals by the central control device 44 and/or the energy management system, for example every 15 minutes for one day in advance.

Consequently, the described embodiment makes it possible simultaneously to reduce the energy efficiency of the heat generation by the heat pump 4 and also the carbon dioxide emissions of the energy system and furthermore to combine both reductions synergistically. Although the teachings herein have been described and illustrated in more detail by way of an example embodiment, the scope of the disclosure is not restricted by the disclosed examples, or other variations may be derived therefrom by a person skilled in the art without departing from the scope of protection thereof.

### LIST OF REFERENCE SIGNS

2 Heat network
3 coupling device
4 Heat pump
5 Heat exchanger
20 Primary side
21 Feed
22 Return
31 Valve
32 Pump
40 Secondary side
42 Control unit
43 Energy management system
44 Central control device

What is claimed is:

1. A control unit for controlling operation of a heat generation installation of an energy system linked to a heat network, the control unit operable to:
control and amount of thermal power fed in from or put out to the heat network;
wherein a weighting g_{e,t} is associated with the feed, a weighting g_{d,t} is associated with the output, and a weighting g_{i,t} is associated with heat generation by the heat generation installation;
determine an excess thermal power P_{excess,t}^{th} from the difference between a maximum thermal power P_{max,t}^{th} of the heat generation installation and a thermal power P_{demand,t}^{th} required for the energy system;
operate the heat generation installation for providing the required thermal power P_{demand,t}^{th} in the time steps for which P_{demand,t}^{th}·g_{d}≥P_{max,t}^{th}·gᵢ−P_{excess,t}^{th}·gₑ; and
put out the excess thermal power P_{excess,t}^{th} generated by the heat generation installation at these points in time into the heat network.

2. The control unit as claimed in claim 1, wherein each of the weightings g_{d}, gᵢ, and gₑ comprises a pollutant variable or an environment variable.

3. The control unit as claimed in claim 1, wherein each of the weightings g_{d}, gᵢ, and gₑ comprises a specific carbon dioxide emission.

4. The control unit as claimed in claim 1, wherein:
the heat generation installation comprises a heat pump with a coefficient of performance COPₜ; and
the control unit determines the maximum thermal power from a maximum electrical power of the heat pump by means of P_{max,t}^{th}=COPₜ·P_{max,t}^{th}.

5. The control unit as claimed in claim 4, wherein the control unit receives at least one measured value of an external temperature Tₜ from a measuring unit of the energy system, and determines therefrom the coefficient of performance COPₜ=COPₜ(Tₜ) as a function of the external temperature Tₜ.

6. The control unit as claimed in claim 1, wherein the control unit adjusts the feeding-in into the heat network so the excess thermal power P_{excess,t}^{th} is fed into a feed of the heat network.

7. The control unit as claimed in claim 1, wherein the control unit controls the feeding-in into the heat network so the excess thermal power P_{excess,t}^{th} is fed into a return of the heat network.

8. The control unit as claimed in claim 6, wherein the control units adjusts the feeding-in into the heat network so the temperature of the return and/or the feed of the heat network is increased by the feeding-in of the excess thermal power P_{excess,t}^{th}.

9. The control unit as claimed in claim 6, wherein the control unit controls the feeding-in and/or outputting from the feed and/or return of the heat network by switching valves.

10. The control unit as claimed in claim 1, comprising a communication module providing data exchange with a central control device connected to a plurality of energy systems;
wherein the central control device controls energy exchanges between the energy systems; and
the communication module receives the weightings g_{d}, gᵢ and gₑ from the central control device.

11. A method for controlling operation of a heat generation installation of an energy system linked to a heat network, the method comprising:
controlling feeding-in and/or feeding-out of a thermal power into the heat network with a control unit, wherein a weighting g_{e,t} is associated with the feeding-in, a weighting g_{d,t} is associated with the feeding-out, and a weighting g_{i,t} is associated with heat generation by the heat generation installation;
determining an excess thermal power P_{excess,t}^{th} from a difference between a maximum thermal power P_{max,t}^{th} of the heat generation installation and a thermal power P_{demand,t}^{th} required for the energy system;
operating the heat generation installation to provide the required thermal power P_{demand,t}^{th} in time steps for which P_{demand,t}^{th}·g_{d}≥P_{max,t}^{th}·gᵢ−P_{excess,t}^{th}·gₑ; and
feeding out any excess thermal power P_{excess,t}^{th} generated by the heat generation installation at the respective points in time into the heat network.

12. The method as claimed in claim 11, wherein feeding-in to the heat network is effected according to a first feed-in mode, wherein the excess thermal power P_{excess,t}^{th} generated by the heat generation installation is transferred to a return of the heat network and the return, the temperature of which has been increased as a result, is fed to a feed of the heat network.

13. The method as claimed in claim 11, wherein the feeding-in to the heat network is effected according to a second feed-in mode, wherein the excess thermal power P_{excess,t}^{th} generated by the heat generation installation is transferred to a return of the heat network and the return, the temperature of which has been increased as a result, is fed back into the return of the heat network.

14. The method as claimed in claim 11, wherein feeding-in to the heat network is effected according to a third feed-in mode, wherein the excess thermal power P_{excess,t}^{th} generated by the heat generation installation is transferred to a feed of the heat network and the feed, the temperature of which has been increased as a result, is fed back into the feed of the heat network.

15. The method as claimed in claim 11, wherein the weightings g_{d}, gᵢ and gₑ are provided by a central control device connected to a plurality of energy systems.
